(19) United States
(12) Patent Application Publication
(10) Pub. No.: US 2026/0073199 A1
(43) Pub. Date: Mar. 12, 2026

(54) ENHANCING ADAPTIVE ROUNDING (ADAROUND) AND LOW-RANK ADAPTATION ROUNDING (LORA-ROUNDING) FOR LARGER DEGREES OF FREEDOM

(71) Applicant: QUALCOMM Incorporated, San Diego, CA (US)

(72) Inventors: Jaeseong YOU, Seoul (KR); Minseop PARK, San Diego, CA (US); Jinkyu LEE, Seoul (KR); Seunghan YANG, Incheon (KR); Yoonhyung LEE, Goyang-si (KR); Sweta PRIYADARSHI, San Diego, CA (US); Markus NAGEL, Amsterdam (NL)

(21) Appl. No.: 18/882,457

(22) Filed: Sep. 11, 2024

(51) Int. Cl. G06N 3/048; G06N 3/0495

(52) U.S. Cl. CPC G06N 3/048; G06N 3/0495

(57) ABSTRACT

Systems and techniques are described herein for adjusting weights of a machine learning (ML) model. For instance, a process can include generating a first matrix of quantized weight values by rounding values of an input matrix of weight values for the ML model; applying an activation function to a second matrix, the second matrix generated based on a third matrix and a fourth matrix of a first matrix pair; applying the activation function to a fifth matrix, the fifth matrix based on a sixth matrix and seventh matrix of a second matrix pair; generating a positive second matrix by applying a positive factor to the second matrix; generating a negative fifth matrix by applying a negative factor to the fifth matrix; and summing the first matrix of quantized weight values with the positive second matrix and the negative fifth matrix to generate an output matrix of quantized weight values.

### FIELD

The present disclosure generally relates to training machine learning (ML) models. For example, aspects of the present disclosure are related to systems and techniques for enhancing adaptive rounding (AdaRound) and low-rank adaptation rounding (LoRA-Rounding) for larger degrees of freedom for ML models.

### BACKGROUND

Machine learning (ML) models, such as a neural network (NN) may include multiple layers of interconnected nodes (e.g., neurons). Each node may include various parameters, such as weights and/or bias values, that may be applied to the nodes, along with an activation function to determine whether a node may be used (e.g., activated). These parameters and activation functions may be tuned during training of the ML model to perform various tasks, such as feature/object detection, recognition, etc. In some cases, a ML model may include many millions of nodes along with the associated parameters and activation functions. These parameters and activation functions may be implemented using 32-bit floating bit values, potentially resulting in a relatively large memory footprint for the ML model.

To help reduce the memory footprint of ML models, a ML model may be quantized. Quantizing a ML model may refer to reducing a precision of the ML model, for example, by converting the 32-bit floating point values to 8-bit values. In some cases, rounding may be used to reduce the precision of the ML model, for example, by rounding the parameters and/or activation functions. While reducing the precision of the ML model may make the ML model less accurate/precise, how the quantization is performed may reduce this loss in accuracy/precision. Additionally, it may be helpful to apply rounding for other purposes, such as finetuning (e.g., tuning weights and/or other parameters of a previously-trained neural network model), domain adaptation (e.g., to a target domain), etc. Thus, improved techniques for rounding may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for adjusting weights of a machine learning (ML) model is provided. The apparatus includes one or more memories and one or more processors coupled to the one or more memories. The one or more processors are configured to: generate a first matrix of quantized weight values by rounding values of an input matrix of weight values for the ML model; apply an activation function to a second matrix, wherein the second matrix is generated based on a third matrix and a fourth matrix of a first matrix pair, and wherein the activation function constrains values of the second matrix to 0 and 1; apply the activation function to a fifth matrix, wherein the fifth matrix is based on a sixth matrix and seventh matrix of a second matrix pair; generate a positive second matrix by applying a positive factor to the second matrix; generate a negative fifth matrix by applying a negative factor to the fifth matrix; sum the first matrix of quantized weight values with the positive second matrix and the negative fifth matrix to generate an output matrix of quantized weight values; and output the output matrix of quantized weight values.

As another example, a method for adjusting weights of a machine learning (ML) model is provided. The method includes: generating a first matrix of quantized weight values by rounding values of an input matrix of weight values for the ML model; applying an activation function to a second matrix, wherein the second matrix is generated based on a third matrix and a fourth matrix of a first matrix pair, and wherein the activation function constrains values of the second matrix to 0 and 1; applying the activation function to a fifth matrix, wherein the fifth matrix is based on a sixth matrix and seventh matrix of a second matrix pair; generating a positive second matrix by applying a positive factor to the second matrix; generating a negative fifth matrix by applying a negative factor to the fifth matrix; summing the first matrix of quantized weight values with the positive second matrix and the negative fifth matrix to generate an output matrix of quantized weight values; and outputting the output matrix of quantized weight values.

In another example, a non-transitory computer-readable medium having stored thereon instructions is provided. The instructions, when executed by one or more processors, cause the one or more processors to: generate a first matrix of quantized weight values by rounding values of an input matrix of weight values for a machine learning (ML) model; apply an activation function to a second matrix, wherein the second matrix is generated based on a third matrix and a fourth matrix of a first matrix pair, and wherein the activation function constrains values of the second matrix to 0 and 1; apply the activation function to a fifth matrix, wherein the fifth matrix is based on a sixth matrix and seventh matrix of a second matrix pair; generate a positive second matrix by applying a positive factor to the second matrix; generate a negative fifth matrix by applying a negative factor to the fifth matrix; sum the first matrix of quantized weight values with the positive second matrix and the negative fifth matrix to generate an output matrix of quantized weight values; and output the output matrix of quantized weight values.

As another example, an apparatus for adjusting weights of a machine learning (ML) model is provided. The apparatus includes: means for generating a first matrix of quantized weight values by rounding values of an input matrix of weight values for the ML model; means for applying an activation function to a second matrix, wherein the second matrix is generated based on a third matrix and a fourth matrix of a first matrix pair, and wherein the activation function constrains values of the second matrix to 0 and 1; means for applying the activation function to a fifth matrix, wherein the fifth matrix is based on a sixth matrix and seventh matrix of a second matrix pair; means for generating a positive second matrix by applying a positive factor to the second matrix; means for generating a negative fifth matrix by applying a negative factor to the fifth matrix; means for summing the first matrix of quantized weight values with the positive second matrix and the negative fifth matrix to generate an output matrix of quantized weight values; and means for outputting the output matrix of quantized weight values.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 illustrates an example implementation of a system-on-a-chip (SOC), in accordance with some examples;

FIG. 2A illustrates an example of a fully connected neural network;

FIG. 2B illustrates an example of a locally connected neural network;

FIG. 2C illustrates an example of a convolutional neural network (CNN);

FIG. 2D illustrates a detailed example of a deep convolutional network (DCN);

FIG. 3 is a block diagram illustrating an example of a deep convolutional network;

FIG. 4A illustrates an example of an AdaRound operation;

FIG. 4B further illustrates an example of an AdaRound operation;

FIG. 5A illustrates an example of a LoRA-Rounding operation;

FIG. 5B illustrates an example of matrix decomposition;

FIG. 6 is a block diagram illustrating a technique for enhanced rounding for larger degrees of freedom, in accordance with aspects of the present disclosure;

FIG. 7 is a flow diagram illustrating a process for adjusting weights of a machine learning (ML) model, in accordance with aspects of the present disclosure; and

FIG. 8 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As noted previously, a large language model (LLM) may be trained to process textual data to perform natural language processing tasks, such as generating, predicting, translating, etc. text. In some cases, a ML model, such as a LLM may be relatively large and it may be useful to quantize the ML model, for example, to reduce the memory footprint of the ML model to allow the ML model to be executed on devices with memory constraints. One technique to perform ML model quantization is adaptive rounding (AdaRound), which may be used to quantize weights and/or other parameters of the ML model. AdaRound uses a learned matrix V that may be a same dimension (e.g., same size) as a matrix of weights being quantized. However, as LLMs may have relatively large weights, using a learned matrix that is dimensionally the same may be resource intensive. Additionally, AdaRound effectively rounds all values down and then determines which values to round up, which may limit expressivity for purposes beyond for quantization optimization to minimize quantization noise.

In some cases, low-rank adaptation rounding (LoRA-Rounding) may be used in place of AdaRound. In LoRA-Rounding, the learned matrix of V may be split into two matrices. However, LoRA-Round may also be difficult to use for a quantized ML model. In some cases, an technique for enhanced rounding with larger degrees of freedom may be useful.

Systems, apparatuses, electronic devices, methods (also referred to as processes), and computer-readable media (collectively referred to herein as “systems and techniques”) are described herein enhanced rounding for larger degrees of freedom. As an example, a matrix of weights from a layer of a ML model may be input for quantization. Weight values of the input matrix of weights may be rounded to generate a quantized matrix (e.g., first matrix) of quantized weight values. In some cases, the rounding may be performed using nearest rounding.

In some aspects, the systems and techniques for enhanced rounding for larger degrees of freedom may also utilize a set of learned matrices. For example, a pair of matrices may form a matrix pair. Each matrix (e.g., third matrix, fourth matrix, sixth matrix, seventh matrix) of the matrix pair may be dimensionally smaller (e.g., smaller in one dimension) as compared to the input matrix of weights. The matrices of the matrix pair may be multiplied together to generate an expanded matrix (e.g., second matrix) and an activation function may be applied to the expanded matrix. In some cases, the expanded matrix may be dimensionally the same as the input matrix of weights. The activation function may constrain values of the expanded matrix to 0 and 1. The expanded matrix may be multiplied with a positive or negative factor. In some cases, two matrix pairs may form a matrix pair set. One expanded matrix (e.g., formed using one matrix pair of a matrix pair set) may be multiplied with a positive factor to obtain a positive expanded matrix (e.g., positive second matrix) of values from 0 and 1. The other expanded matrix may be multiplied with a negative factor to obtain a negative expanded matrix (e.g., negative fifth matrix) of values from −1 to 0. The expanded matrices from a matrix pair set may be summed to generate a matrix of values from −1 to 1. In some cases, there may be N number of matrix pair sets and expanded matrices from the N number of matrix pair sets may be summed to generate an output matrix of values from −N to N. Values of the output matrix may be used by a quantized version of the ML model as weights.

Various aspects of the present disclosure will be described with respect to the figures.

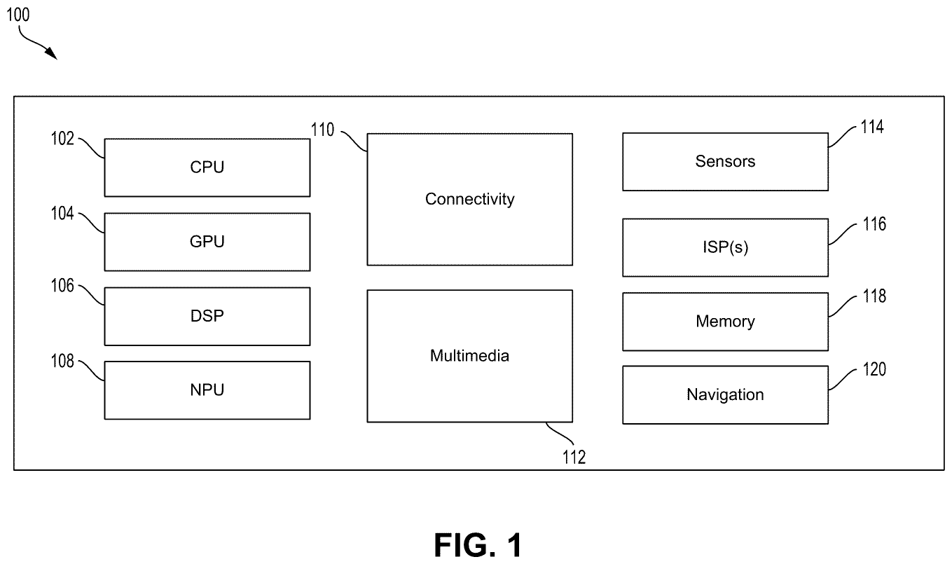

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

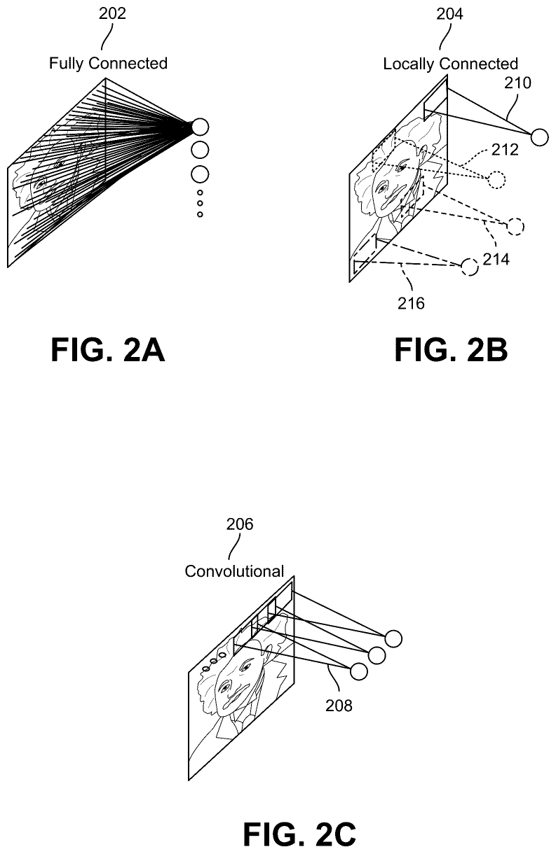

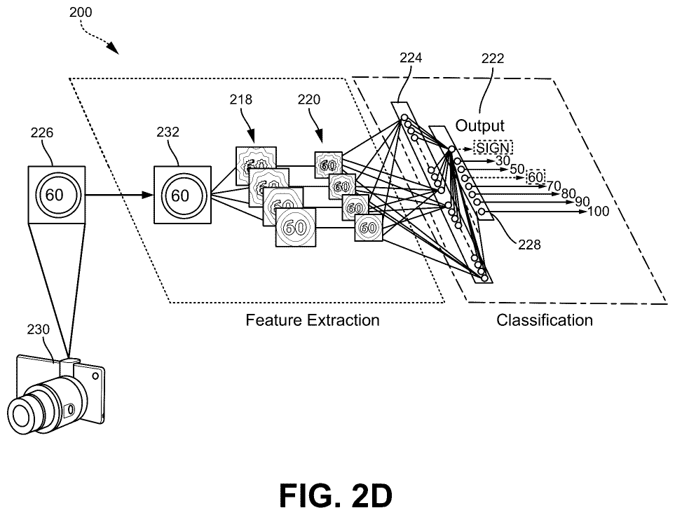

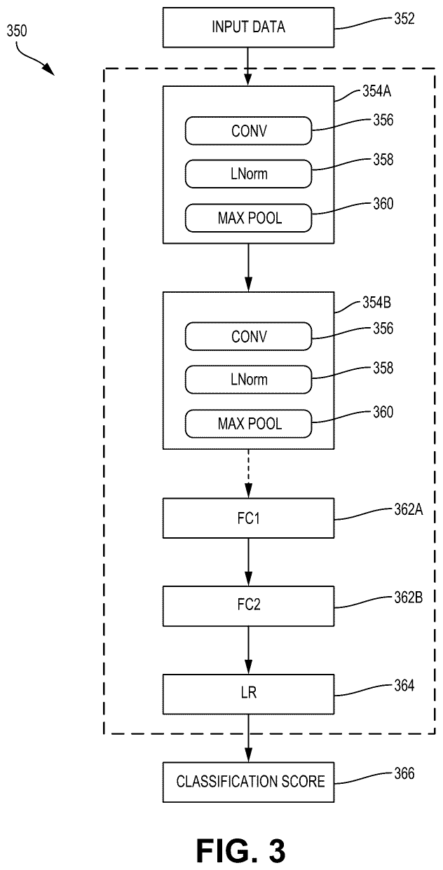

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connect-ed. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decom-pression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as an image capture and processing system based on SOC 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A Softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. Adjusting the weights in such a manner may be referred to as “back propagation” as it involves a “backward pass” through the neural network.

In practice, the error gradient of weights may be calculated over a small number of examples, so that the calculated gradient approximates the true error gradient. The approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and out-put targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

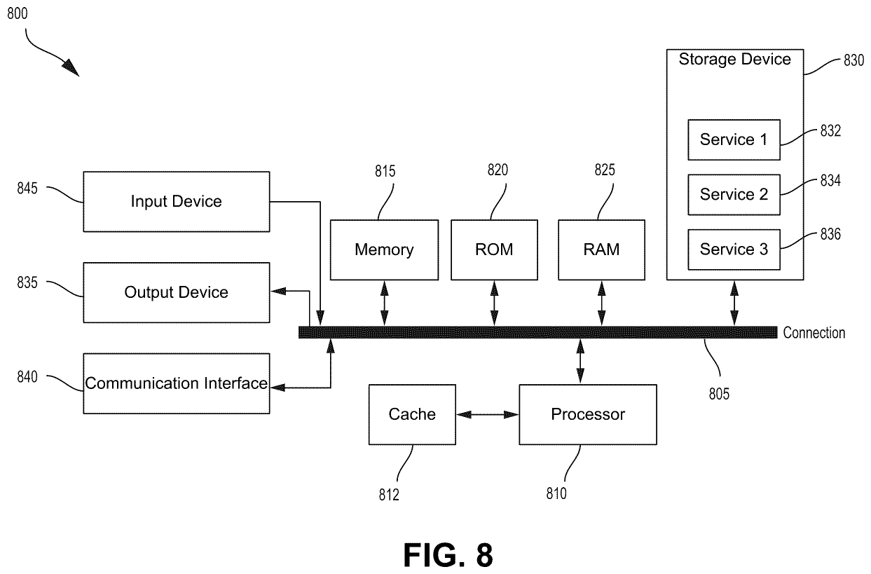

The parallel filter banks, for example, of a deep convolutional network may be loaded on a processor such as a CPU, GPU, NPU, or any other type of processor 1010 discussed with respect to the computing device architecture 800 of FIG. 8 to achieve high performance and low power consumption. In alternative aspects, the parallel filter banks may be loaded on a DSP or an ISP of the computing device architecture 800 of FIG. 8. In addition, the deep convolutional network 350 may access other processing blocks that may be present on the computing device architecture 800 of FIG. 8, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. The set of DCNs may function as feature extractors to identify features in an image. In some cases, feature extractors may be used as a backbone for additional ML network components to perform further operations, such as image segmentation.

In some cases, CNN and/or DCNs may be generalized in the form of a transformer network. A transformer network may extract features from an input sequence and the transformer network may include attention mechanisms that may enable the transformer network to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer network may include a series of feedforward layers whose configurations may change in response to identifying non-linear relationships between the input and output sequences, which may also be referred to as a process of “learning” by the layers. The output of a transformer structure may be obtained by applying a linear transformation to the output of a final attention layer. A transformer structure may be of particular use for tasks that involve sequence modeling, text generation, or other like processing.

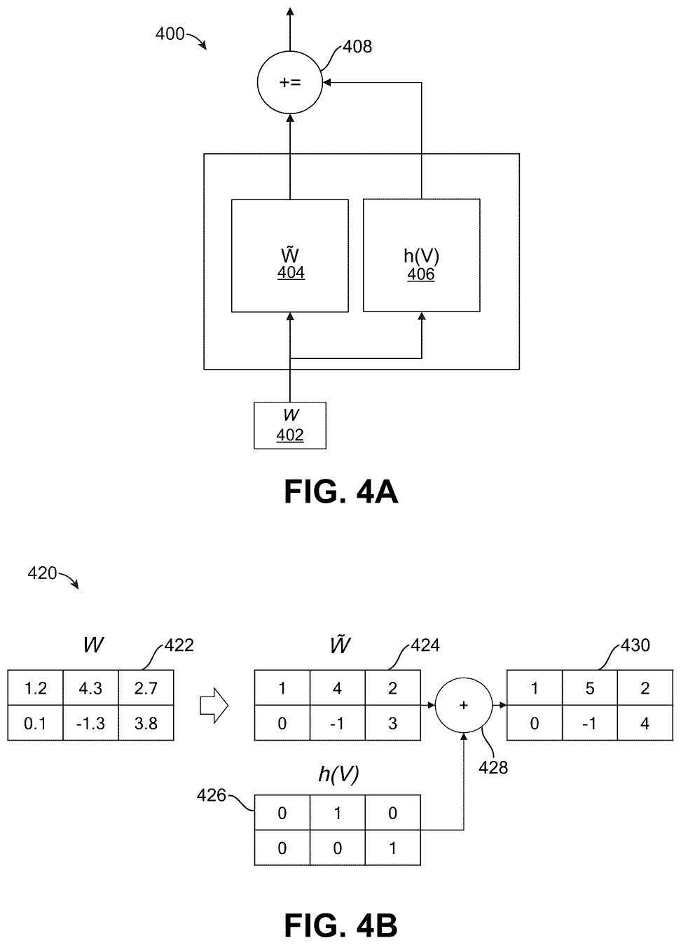

FIG. 4A illustrates an example of an AdaRound operation 400. In some cases, it may be useful to quantize a ML model, for example, to reduce the memory footprint of the ML model to allow the ML model to be executed on devices with memory constraints. Quantization of a ML model may be performed using a pretrained ML model via post-training quantization. Post-training quantization may allow pretrained ML models to be quantized without have to retrain the ML model and/or perform hyperparameter tuning. One technique to perform post-training quantization is adaptive rounding (AdaRound), which may be used to quantize weights and/or other parameters of the ML model. AdaRound formulates a per-layer rounding solution taking into consideration characteristics of input data to the layer. In AdaRound the weight matrix W 402 may be quantized by dividing the weight matrix W 402 by a scaler s and flooring the result to obtain quantized weight matrix W 424. In some cases, the scaler s scales a tensor so that it is within a particular range. The quantized weight matrix W 424 may be added 408 with activation function h (V) 406 to govern what elements in W to round up. By flooring the quantized weight matrix W 402, AdaRound effectively rounds down by default and then rounds up values of the quantized weight matrix W 424 based on the learned matrix V.

FIG. 4B further illustrates an example of an AdaRound operation 420. AdaRound may round weights based on Equation 1:

$$\tilde{W} = s * clip ( ⌊ \frac{W}{s} ⌋ + h ( V ) , n , p ) , \qquad Equation 1$$

where W 422 is a given weight matrix having a shape of d×k (e.g., 3×2 in FIG. 4B), \tilde{W} 424 is the quantized weight matrix, also having a shape of d×k, V is a learned matrix having the same shape of d, k, h is an activation function which condenses values of V towards 0 and 1 (e.g., h(V) 426, where n, p define an integer range for the rounding, and where values of \tilde{W} are within the integer range. The activation function h may be represented as Equation 2:

$$h ( {V}_{i , j} ) = clip ( σ ( {V}_{i , j} ) ( ζ - γ ) + γ , 0 , 1 ) , \qquad Equation 2$$

which condenses values towards 0 and 1 and limits the range to 0, 1. The matrix V includes values that are learned through training and the values of V may be learned to minimize the function ƒ. As matrix V is learned, the values of matrix V may differ weight by weight. The function ƒ may be a regularization function represented as Equation 3:

$${f}_{reg} ( V ) = {\sum }_{i , j} 1 - {\vert 2 h ( {V}_{i , j} ) - 1 \vert}^{β} , \qquad Equation 3$$

which pushes values of V toward either 0 or 1. Thus, minimizing the function ƒ happens when values of V are either 0 or 1. The overall quantization objective for learning values of V may be defined as Equation 4:

$${arg min}_{V} {‖ Wx - \hat{W} x ‖}_{F}^{2} + λ {f}_{reg} ( V ) , \qquad Equation 4$$

where Wx represents a prediction without quantization and where Ŵx represents an output taking the effect of the quantization. The effect is to make Wx and Ŵx as similar as possible while the values of V remain 0 and 1. As shown, quantized weight matrix \tilde{W} 424 May be summed 428 with h(V) 426 to generate an output weight 430. That may be used for the quantized ML model.

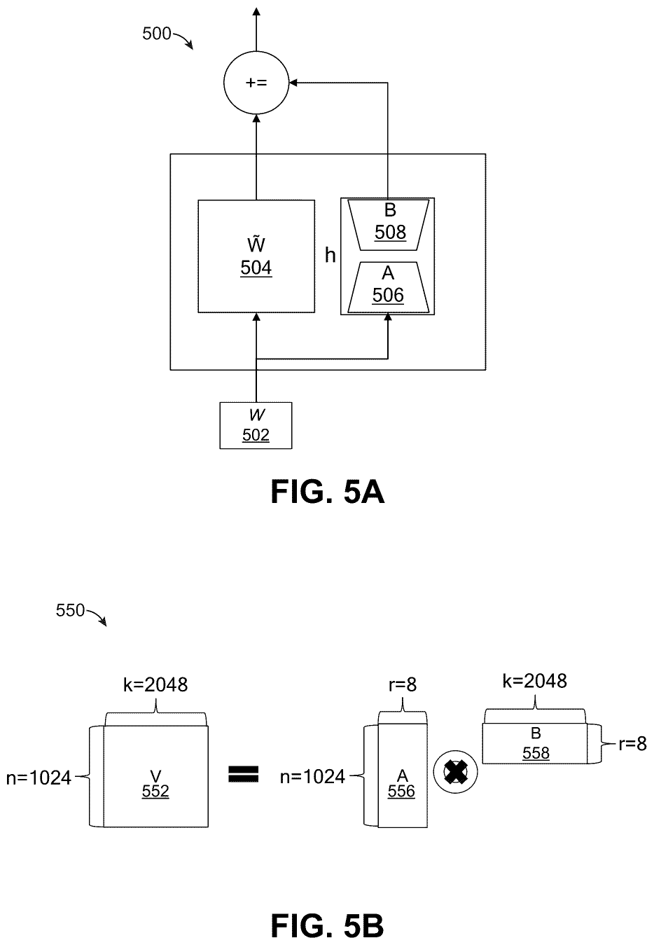

FIG. 5A illustrates an example of a LoRA-Rounding operation 500. In some cases, LoRA-Rounding may be used in place of AdaRound for quantizing a ML model. As shown in FIG. 5A, LoRA-Rounding may be similar to AdaRound as a weight matrix W 502 may be quantized to a weight matrix \tilde{W} 504. In LoRA-Rounding, the learned matrix V of AdaRound may be spilt into matrix A 506 and matrix B 508.

FIG. 5B illustrates an example of matrix decomposition 550. The learned matrix V 552 of AdaRound may be split (e.g., decomposed) into multiple matrices because learned matrix V 552 may be overparameterized, sparse, and low-rank. For example, in FIG. 5B learned matrix V 552 has dimensions of k×n, where k=2048 and n=1024, and the learned matrix V 552 may be decomposed into matrix A 556 having dimensions of r×n, where r represents a reduced dimension size (e.g., 8 in FIG. 5B) and where r may be substantially smaller than k, and matrix B 558 having dimensions of k×r. This decomposition may be expressed as V=A×B, A∈ [symbol] ^{d×r}, B∈ [symbol] ^{r×k}. In some cases, LoRA-Rounding may be trained in a manner substantially similar to training in AdaRound.

In some cases, AdaRound may be relatively limited in expressivity for purposes (e.g., finetuning, domain adaptation, etc.) other than quantization optimization to minimize quantization noise as AdaRound effectively rounds all values down and then determines which values to round up. Additionally, AdaRound uses a weight matrix V that is the same size (e.g., has the same dimensions) as the input weight, which can be memory intensive when used with ML models, such as large language models, which use large weights. In some cases, LoRA-Rounding may also be difficult to apply outside of quantization optimization as it may be difficult to fold a LoRA-Rounded weight into a quantized model. In some cases, folding may merge an auxiliary weight into a corresponding main weight. For example, LoRA-Rounded weights A and B can be expanded and added onto W so that you no longer need to keep additional A & B. In the context of quantization, W may be in the integer form. To add AB onto it, AB should also be in the integer form. The enhanced rounding technique keeps A and B in the integer form, so that they can be added onto W without any modifications (which may incur additional overhead and/or quantization error). Additionally, LoRA-Rounding based finetuning may not quantization-aware, thus making LoRA-Rounding difficult to use for finetuning a quantized ML model and resulting quantization noise. In some cases, an enhanced rounding technique allowing for larger degrees of freedom may be useful.

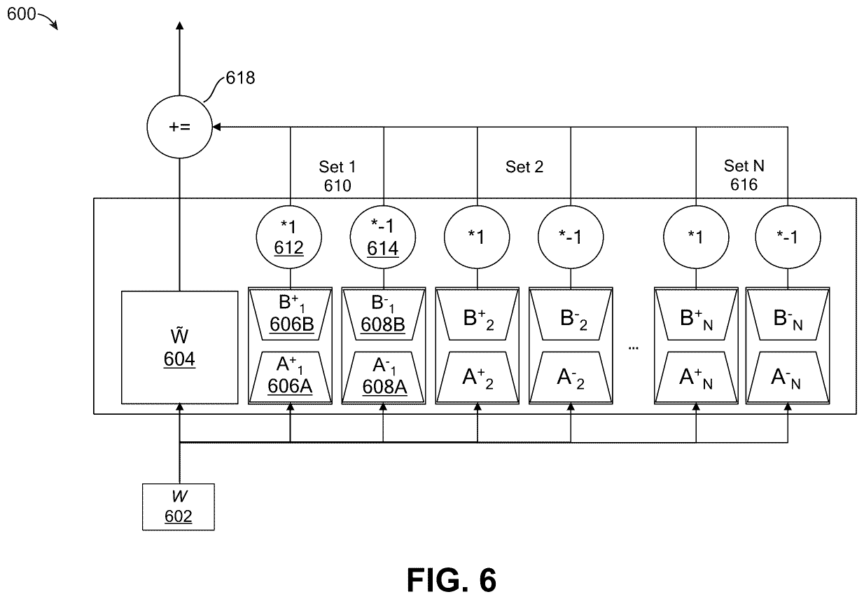

FIG. 6 is a block diagram illustrating a technique 600 for enhanced rounding for larger degrees of freedom, in accordance with aspects of the present disclosure. As shown in FIG. 6, a weight matrix W 602 may be input and quantized to a weight matrix W 604 using nearest rounding (e.g., rounding values of the weight matrix W 602 to a nearest whole number). The technique 600 uses a number of matrix pairs (e.g., 2N matrix pairs), such as matrix A⁺₁ 606A and matrix B⁺₁ 606B or matrix A⁻₁ 608A and matrix B⁻₁ 608B. Each matrix of the matrix pair may be dimensionally smaller than the input weight matrix W 602. The matrices of the matrix pair, such as matrix A⁺₁ 606A and matrix B⁺₁ 606B, when multiplied together may form an expanded matrix that may have a dimension equal to dimensions of the input weight matrix W 602 (e.g., in a manner similar to matrix V of AdaRound) and values of 0 and 1 (e.g., constrained by an activation function such as activation function h as discussed above with respect to Equation 2). In some cases, two matrix pairs may form a set of matrix pairs. For example, matrix pair set 1 610 may include a first matrix pair including matrix A⁺₁ 606A and matrix B⁺₁ 606B and a second matrix pair including matrix A⁻₁ 608A and matrix B⁻₁ 608B.

A first expanded matrix, formed from a matrix pair, of a set of matrix pairs, may be multiplied by a positive factor to generate a positive first expanded matrix. A second expanded matrix, formed from the other matrix pair, of the set of matrix pairs, may be multiplied by a negative factor to generate a negative second expanded matrix. For example, a first expanded matrix obtained by multiplying matrix A⁺₁ 606A and matrix B⁺₁ 606B may be multiplied by a positive factor 612, and a second expanded matrix obtained by multiplying matrix A⁻₁ 608A and matrix B⁻₁ 608B may be multiplied by a negative factor 614. The first expanded matrix may then have integer values from 0 to 1, while the second expanded matrix may have integer values from 0 to −1. The matrix pair set 1 610 may then have integer values from −1 to 1 (e.g., values of −1, 0, and 1). As there may be N matrix pair sets, from matrix pair set 1 610 to matrix pair set N 616, each matrix pair set having integer values distributed from −1 to 1 (e.g., values of −1, 0, and 1), when summed 618 has a total range of values of integers from −N to N (e.g., values of −N, . . . −1, 0, 1, . . . . N). This integer range from −N to N may allow for enhanced expressivity, as compared to the integer range of 0 to 1, that may be useful for, for example, enhanced quantization optimization, finetuning, domain adaptation, etc. The expanded matrices may be summed 618 with the weight matrix \tilde{W} 604 to generate an output quantized matrix of weight values for output (e.g., use in a quantized version of the ML model as weights). In some cases, N may be a hyperparameter that may be tuned, depending on, for example, an amount of capacity expected (e.g., amount of domain shift expected) taking into account an integer bit width of the weight matrix \tilde{W} 604.

In some cases, to train matrices of the matrix pairs, matrix Bs (e.g., matrix B⁺₁ 606B, matrix B⁻₁ 608B, etc.) may be initialized to all zeros and matrix As (e.g., matrix A⁺₁ 606A, matrix A⁻₁ 608A, etc.) may be initialized randomly. In some cases, matrix As values may be normalized using a same normalized normal distribution. Matrix Bs may be initialized to zeros to start with no effect initially, which may then change as training proceeds. As indicated above, each matrix of the number of matrix pairs may follow the matrix constraints from AdaRound (e.g., Equation 2 and Equation 3). In some cases, weight matrix \tilde{W} 604, matrix As, and matrix Bs may be regularized (e.g., clipped) to avoid integer overflows. Training may be performed to minimize a mean squared error (MSE) loss between the quantized weight matrix \tilde{W} 604 and the summed expanded matrices (which were multiplied by the factors) as input to be summed 618. In some cases, when used for fine tuning, the MSE loss may be replaced by a task loss.

In some cases, the technique 600 for enhanced rounding for larger degrees of freedom may be used to quantize pre-trained ML models (e.g., ML model with trained weights). For example, the technique 600 for enhanced rounding for larger degrees of freedom may be performed using an enhanced rounding engine. A pre-trained ML model may be quantized by attaching enhanced rounding engines to the linear layers of the pre-trained ML model to quantize weights of those linear layers. Training of the technique 600 may be performed by initializing the matrices of the matrix pairs as discussed above, and quantizing the weights of the linear layers of the pre-trained ML model using the initialized values. Training data (which may be different from the training data used to pre-train the ML model itself) may be passed through the quantized pre-trained ML model and a loss determined in a manner similar to that described in Equation 4 above for adjusting the matrices of the matrix pairs of the enhanced rounding engines.

In some cases, training for the technique 600 may be performed as a part of training the ML model. For example, the ML model may be trained and weights frozen. The enhanced rounding engines may be attacked to the linear layers of the ML model and trained, for example, using the training data for training the ML model. Outputs of the non-quantized ML model and the outputs of the quantized model may be compared to determine a loss value for adjusting the matrices of the matrix pairs of the enhanced rounding engines.

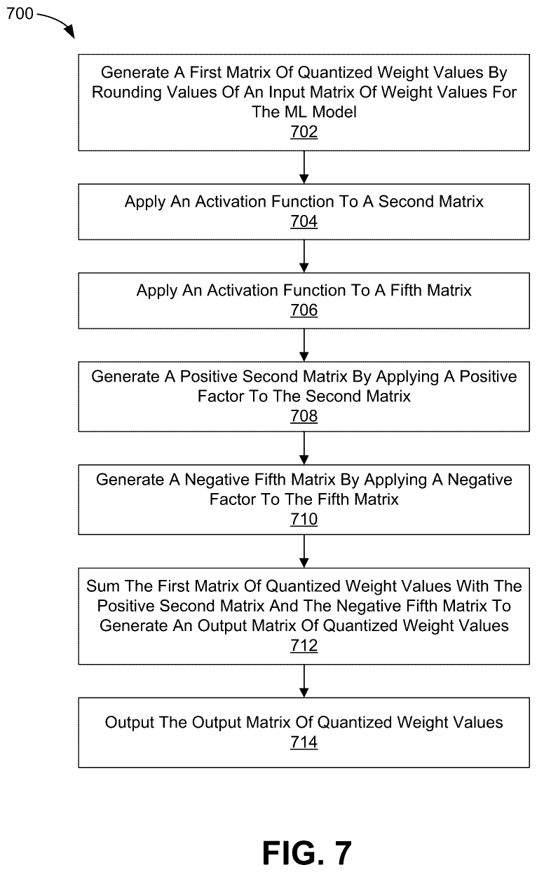

FIG. 7 is a flow diagram illustrating a process 700 for adjusting weights of a machine learning (ML) model, in accordance with aspects of the present disclosure. The process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. In some cases, the computing device may be or may include coding device, such as an encoding device, decoding device, or a combined encoding device (or codec). The operations of the process 700 may be implemented as software components that are executed and run on one or more processors (such as CPU 102, GPU 104, DSP 106, NPU 108 of FIG. 1, processor 810 of FIG. 8, etc.).

At block 702, the computing device (or component thereof) may generate a first matrix of quantized weight values (e.g., weight matrix \acute{W} 604 of FIG. 6) by rounding values of an input matrix of weight values for the ML model. In some examples, the rounding comprises nearest rounding.

At block 704, the computing device (or component thereof) may apply an activation function (e.g., activation function h) to a second matrix. In some examples, the second matrix is generated based on a third matrix and a fourth matrix of a first matrix pair (e.g., first matrix pair including matrix A⁺₁ 606A and matrix B⁺₁ 606B of FIG. 6). In some cases, the activation function constrains values of the second matrix to 0 and 1.

At block 706, the computing device (or component thereof) may apply the activation function to a fifth matrix. In some examples, the fifth matrix is based on a sixth matrix and seventh matrix of a second matrix pair (e.g., second matrix pair including matrix A⁻₁ 608A and matrix B⁻₁ 608B of FIG. 6). In some examples, the first matrix pair and second matrix pair form a matrix pair set and the computing device (or component thereof) may generate a positive matrix and a negative matrix for matrix pairs of each matrix pair set. In some cases, the third matrix, fourth matrix, sixth matrix, and seventh matrix are dimensionally smaller than the input matrix of weight values. In some examples, the second matrix and fifth matrix have a same dimensions as the input matrix of weight values.

At block 708, the computing device (or component thereof) may generate a positive second matrix by applying a positive factor (e.g., positive factor 612 of FIG. 6) to the second matrix.

At block 710, the computing device (or component thereof) may generate a negative fifth matrix by applying a negative factor (e.g., negative factor 614 of FIG. 6) to the fifth matrix. In some examples, the positive factor comprises 1 and wherein the negative factor comprises −1.

At block 712, the computing device (or component thereof) may sum (e.g., summed 618 of FIG. 6) the first matrix of quantized weight values with the positive second matrix and the negative fifth matrix to generate an output matrix of quantized weight values. In some examples, a range of values of the output matrix of quantized weight values is based on a number of matrix pair sets. In some cases, the number of matrix pair sets are configurable as a hyperparameter.

At block 714, the computing device (or component thereof) may output the output matrix of quantized weight values.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 700 and/or other processes described herein may include a processor, microprocessor, micro-computer, or other component of a device that is configured to carry out the steps of the process 700 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 700 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 700 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 800 are shown in electrical communication with each other using connection 805, such as a bus. The example computing device architecture 800 includes a processing unit (CPU or processor) 810 and computing device connection 805 that couples various computing device components including computing device memory 815, such as read only memory (ROM) 820 and random access memory (RAM) 825, to processor 810.

Computing device architecture 800 can include a cache of high-speed memory connected directly with, in close proximity to, or integrated as part of processor 810. Computing device architecture 800 can copy data from memory 815 and/or the storage device 830 to cache 812 for quick access by processor 810. In this way, the cache can provide a performance boost that avoids processor 810 delays while waiting for data. These and other modules can control or be configured to control processor 810 to perform various actions. Other computing device memory 815 may be available for use as well. Memory 815 can include multiple different types of memory with different performance characteristics. Processor 810 can include any general purpose processor and a hardware or software service, such as service 1 832, service 2 834, and service 3 836 stored in storage device 830, configured to control processor 810 as well as a special-purpose processor where software instructions are incorporated into the processor design. Processor 810 may be a self-contained system, containing multiple cores or processors, a bus, memory controller, cache, etc. A multi-core processor may be symmetric or asymmetric.

To enable user interaction with the computing device architecture 800, input device 845 can represent any number of input mechanisms, such as a microphone for speech, a touch-sensitive screen for gesture or graphical input, keyboard, mouse, motion input, speech and so forth. Output device 835 can also be one or more of a number of output mechanisms known to those of skill in the art, such as a display, projector, television, speaker device, etc. In some instances, multimodal computing devices can enable a user to provide multiple types of input to communicate with computing device architecture 800. Communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. Storage device 830 can include services 832, 834, 836 for controlling processor 810. Other hardware or software modules are contemplated. Storage device 830 can be connected to the computing device connection 805. In one aspect, a hardware module that performs a particular function can include the software component stored in a computer-readable medium in connection with the necessary hardware components, such as processor 810, connection 805, output device 835, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology May be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for adjusting weights of a machine learning (ML) model, comprising: one or more memories; and one or more processors coupled to the one or more memories and configured to: generate a first matrix of quantized weight values by rounding values of an input matrix of weight values for the ML model; apply an activation function to a second matrix, wherein the second matrix is generated based on a third matrix and a fourth matrix of a first matrix pair, and wherein the activation function constrains values of the second matrix to 0 and 1; apply the activation function to a fifth matrix, wherein the fifth matrix is based on a sixth matrix and seventh matrix of a second matrix pair; generate a positive second matrix by applying a positive factor to the second matrix; generate a negative fifth matrix by applying a negative factor to the fifth matrix; sum the first matrix of quantized weight values with the positive second matrix and the negative fifth matrix to generate an output matrix of quantized weight values; and output the output matrix of quantized weight values.
Aspect 2. The apparatus of Aspect 1, wherein the first matrix pair and second matrix pair form a matrix pair set and further comprising generating a positive matrix and a negative matrix for matrix pairs of each matrix pair set.
Aspect 3. The apparatus of Aspect 2, wherein a range of values of the output matrix of quantized weight values is based on a number of matrix pair sets.
Aspect 4. The apparatus of Aspect 3, wherein the number of matrix pair sets are configurable as a hyperparameter.
Aspect 5. The apparatus of any of Aspects 1-4, wherein the positive factor comprises 1 and wherein the negative factor comprises −1.
Aspect 6. The apparatus of any of Aspects 1-5, wherein the third matrix, fourth matrix, sixth matrix, and seventh matrix are dimensionally smaller than the input matrix of weight values, and wherein the second matrix and fifth matrix have a same dimensions as the input matrix of weight values.
Aspect 7. The apparatus of any of Aspects 1-6, wherein the rounding comprises nearest rounding.
Aspect 8. A method for adjusting weights of a machine learning (ML) model, comprising: generating a first matrix of quantized weight values by rounding values of an input matrix of weight values for the ML model; applying an activation function to a second matrix, wherein the second matrix is generated based on a third matrix and a fourth matrix of a first matrix pair, and wherein the activation function constrains values of the second matrix to 0 and 1; applying the activation function to a fifth matrix, wherein the fifth matrix is based on a sixth matrix and seventh matrix of a second matrix pair; generating a positive second matrix by applying a positive factor to the second matrix; generating a negative fifth matrix by applying a negative factor to the fifth matrix; summing the first matrix of quantized weight values with the positive second matrix and the negative fifth matrix to generate an output matrix of quantized weight values; and outputting the output matrix of quantized weight values.
Aspect 9. The method of Aspect 8, wherein the first matrix pair and second matrix pair form a matrix pair set and further comprising generating a positive matrix and a negative matrix for matrix pairs of each matrix pair set.
Aspect 10. The method of Aspect 9, wherein a range of values of the output matrix of quantized weight values is based on a number of matrix pair sets.
Aspect 11. The method of Aspect 10, wherein the number of matrix pair sets are configurable as a hyperparameter.
Aspect 12. The method of any of Aspects 8-11, wherein the positive factor comprises 1 and wherein the negative factor comprises −1.
Aspect 13. The method of any of Aspects 8-12, wherein the third matrix, fourth matrix, sixth matrix, and seventh matrix are dimensionally smaller than the input matrix of weight values, and wherein the second matrix and fifth matrix have a same dimensions as the input matrix of weight values.
Aspect 14. The method of any of Aspects 8-13, wherein the rounding comprises nearest rounding.
Aspect 15. A non-transitory computer-readable medium having stored thereon instructions that, when executed by one or more processors, cause the one or more processors to: generate a first matrix of quantized weight values by rounding values of an input matrix of weight values for a machine learning (ML) model; apply an activation function to a second matrix, wherein the second matrix is generated based on a third matrix and a fourth matrix of a first matrix pair, and wherein the activation function constrains values of the second matrix to 0 and 1; apply the activation function to a fifth matrix, wherein the fifth matrix is based on a sixth matrix and seventh matrix of a second matrix pair; generate a positive second matrix by applying a positive factor to the second matrix; generate a negative fifth matrix by applying a negative factor to the fifth matrix; sum the first matrix of quantized weight values with the positive second matrix and the negative fifth matrix to generate an output matrix of quantized weight values; and output the output matrix of quantized weight values.
Aspect 16. The non-transitory computer-readable medium of Aspect 15, wherein the first matrix pair and second matrix pair form a matrix pair set and further comprising generating a positive matrix and a negative matrix for matrix pairs of each matrix pair set.
Aspect 17. The non-transitory computer-readable medium of Aspect 16, wherein a range of values of the output matrix of quantized weight values is based on a number of matrix pair sets.
Aspect 18. The non-transitory computer-readable medium of Aspect 17, wherein the number of matrix pair sets are configurable as a hyperparameter.
Aspect 19. The non-transitory computer-readable medium of any of Aspects 15-19, wherein the positive factor comprises 1 and wherein the negative factor comprises −1.
Aspect 20. The non-transitory computer-readable medium of any of Aspects 15-19, wherein the third matrix, fourth matrix, sixth matrix, and seventh matrix are dimensionally smaller than the input matrix of weight values, and wherein the second matrix and fifth matrix have a same dimensions as the input matrix of weight values.
Aspect 21. The non-transitory computer-readable medium of any of Aspects 15-20, wherein the rounding comprises nearest rounding.
Aspect 22: An apparatus for or adjusting weights of a machine learning (ML) model, comprising one or more means for performing any of the operations of Aspects 8 to 14.

What is claimed is:

1. An apparatus for adjusting weights of a machine learning (ML) model, comprising:
one or more memories; and
one or more processors coupled to the one or more memories and configured to:
generate a first matrix of quantized weight values by rounding values of an input matrix of weight values for the ML model;
apply an activation function to a second matrix, wherein the second matrix is generated based on a third matrix and a fourth matrix of a first matrix pair, and wherein the activation function constrains values of the second matrix to 0 and 1;
apply the activation function to a fifth matrix, wherein the fifth matrix is based on a sixth matrix and seventh matrix of a second matrix pair;
generate a positive second matrix by applying a positive factor to the second matrix;
generate a negative fifth matrix by applying a negative factor to the fifth matrix;
sum the first matrix of quantized weight values with the positive second matrix and the negative fifth matrix to generate an output matrix of quantized weight values; and
output the output matrix of quantized weight values.

2. The apparatus of claim 1, wherein the first matrix pair and second matrix pair form a matrix pair set and further comprising generating a positive matrix and a negative matrix for matrix pairs of each matrix pair set.

3. The apparatus of claim 2, wherein a range of values of the output matrix of quantized weight values is based on a number of matrix pair sets.

4. The apparatus of claim 3, wherein the number of matrix pair sets are configurable as a hyperparameter.

5. The apparatus of claim 1, wherein the positive factor comprises 1 and wherein the negative factor comprises −1.

6. The apparatus of claim 1, wherein the third matrix, fourth matrix, sixth matrix, and seventh matrix are dimensionally smaller than the input matrix of weight values, and wherein the second matrix and fifth matrix have a same dimensions as the input matrix of weight values.

7. The apparatus of claim 1, wherein the rounding comprises nearest rounding.

8. A method for adjusting weights of a machine learning (ML) model, comprising:
generating a first matrix of quantized weight values by rounding values of an input matrix of weight values for the ML model;
applying an activation function to a second matrix, wherein the second matrix is generated based on a third matrix and a fourth matrix of a first matrix pair, and wherein the activation function constrains values of the second matrix to 0 and 1;
applying the activation function to a fifth matrix, wherein the fifth matrix is based on a sixth matrix and seventh matrix of a second matrix pair;
generating a positive second matrix by applying a positive factor to the second matrix;
generating a negative fifth matrix by applying a negative factor to the fifth matrix;
summing the first matrix of quantized weight values with the positive second matrix and the negative fifth matrix to generate an output matrix of quantized weight values; and
outputting the output matrix of quantized weight values.

9. The method of claim 8, wherein the first matrix pair and second matrix pair form a matrix pair set and further comprising generating a positive matrix and a negative matrix for matrix pairs of each matrix pair set.

10. The method of claim 9, wherein a range of values of the output matrix of quantized weight values is based on a number of matrix pair sets.

11. The method of claim 10, wherein the number of matrix pair sets are configurable as a hyperparameter.

12. The method of claim 8, wherein the positive factor comprises 1 and wherein the negative factor comprises −1.

13. The method of claim 8, wherein the third matrix, fourth matrix, sixth matrix, and seventh matrix are dimensionally smaller than the input matrix of weight values, and wherein the second matrix and fifth matrix have a same dimensions as the input matrix of weight values.

14. The method of claim 8, wherein the rounding comprises nearest rounding.

15. A non-transitory computer-readable medium having stored thereon instructions that, when executed by one or more processors, cause the one or more processors to:
generate a first matrix of quantized weight values by rounding values of an input matrix of weight values for a machine learning (ML) model;
apply an activation function to a second matrix, wherein the second matrix is generated based on a third matrix and a fourth matrix of a first matrix pair, and wherein the activation function constrains values of the second matrix to 0 and 1;
apply the activation function to a fifth matrix, wherein the fifth matrix is based on a sixth matrix and seventh matrix of a second matrix pair;
generate a positive second matrix by applying a positive factor to the second matrix;
generate a negative fifth matrix by applying a negative factor to the fifth matrix;
sum the first matrix of quantized weight values with the positive second matrix and the negative fifth matrix to generate an output matrix of quantized weight values; and
output the output matrix of quantized weight values.

16. The non-transitory computer-readable medium of claim 15, wherein the first matrix pair and second matrix pair form a matrix pair set and further comprising generating a positive matrix and a negative matrix for matrix pairs of each matrix pair set.

17. The non-transitory computer-readable medium of claim 16, wherein a range of values of the output matrix of quantized weight values is based on a number of matrix pair sets.

18. The non-transitory computer-readable medium of claim 17, wherein the number of matrix pair sets are configurable as a hyperparameter.

19. The non-transitory computer-readable medium of claim 15, wherein the positive factor comprises 1 and wherein the negative factor comprises −1.

20. The non-transitory computer-readable medium of claim 15, wherein the third matrix, fourth matrix, sixth matrix, and seventh matrix are dimensionally smaller than the input matrix of weight values, and wherein the second matrix and fifth matrix have a same dimensions as the input matrix of weight values.
